(19) United States
(12) Patent Application Publication
(10) Pub. No.: US 2026/0098584 A1
(43) Pub. Date: Apr. 9, 2026

(54) Erosion Resistant Gate Valve

(71) Applicant: NovaVia LLC, Richmond, TX (US)

(72) Inventor: Jonathan M. Durham, Richmond, TX (US)

(21) Appl. No.: 19/349,227

(22) Filed: Oct. 3, 2025

Related U.S. Application Data
(60) Provisional application No. 63/703,087, filed on Oct. 3, 2024.

(51) Int. Cl. F16K 3/314; F16K 3/02

(52) U.S. Cl. CPC F16K 3/314; F16K 3/0209

(57) ABSTRACT

A gate for a gate valve includes a gate bore extending from a first surface to a second surface, the gate bore having a central axis and an axis of symmetry and a pocket formed in the first surface along an arcuate portion of the gate bore and bisected by the axis of symmetry, the pocket defined by a bottom surface, a first sidewall, an opposite sidewall, and an outside edge where the bottom surface extends radially from an entrance edge of the gate bore recessed from the first surface to the outside edge, the first sidewall extends from the entrance edge to the outside edge, and the opposite sidewall extending from the entrance edge to the outside edge.

### TECHNICAL FIELD

This disclosure relates in general to the field of flow control devices, and more particularly, to erosion resistant flow control devices.

### BACKGROUND

This section provides background information to facilitate a better understanding of the various aspects of the disclosure and is not an admission of prior art.

Gate valves are typically used in one of two states: fully opened or fully closed. Intentional throttling of fluid flow between these two states typically is not done with a gate valve, especially when used with abrasive fluids. When the gate valve is transitioned from the fully opened state to the fully closed state, the overlap between the gate bore and the valve body flow path is increasingly restricted. As the overlap between the gate bore and flow path is further diminished, the overlap continually reduces to a point immediately prior to the fully closed condition. A nozzle effect may be created by this reducing overlap that projects the flow, including abrasive particles in the flow, at increasingly higher velocities and in a concentrated stream and direction. In other words, in the fully opened condition the fluid flow may be described, without limitation, by a vector with an average flow rate or velocity and an average or representative direction, which direction is generally parallel to the flow path through the valve. The flow in the fully opened condition also may be described as laminar flow. However, as the gate transitions from the fully opened flow position to the fully closed position (or from fully closed to open), the fluid flow vector will begin to change in both magnitude and direction. The maximum flow rate (e.g., velocity) is typically greatest right before the fully closed condition is reached (or just upon opening). The nozzle effect created by the diminishing overlap between the gate bore and the flow path causes the direction of the flow to change from the direction in the fully opened flow state. Often, the changed direction will cause the increased velocity flow to impinge on and erode critical areas of parts of the valve assembly in the flow path.

### SUMMARY

An example gate for a gate valve includes a gate bore extending from a first surface to a second surface, the gate bore having a central axis and an axis of symmetry and a pocket formed in the first surface along an arcuate portion of the gate bore and bisected by the axis of symmetry, the pocket defined by a bottom surface, a first sidewall, an opposite sidewall, and an outside edge where the bottom surface extends radially from an entrance edge of the gate bore recessed from the first surface to the outside edge, the first sidewall extends from the entrance edge to the outside edge, and the opposite sidewall extending from the entrance edge to the outside edge.

Another example gate for a gate valve includes a gate bore extending from a first surface to a second surface, the gate bore having a central axis and an axis of symmetry and a pocket formed in the first surface along an arcuate portion of the gate bore and bisected by the axis of symmetry, the pocket defined by a backwall, a bottom surface, a first sidewall, and an opposite sidewall where the backwall is vertically recessed from the first surface and radially displaced from the gate bore, the bottom surface extends from the backwall to an entrance edge of the gate bore recessed from the first surface, the bottom surface extends radially from the entrance edge to the backwall, the first sidewall extends from the entrance edge to the outside edge, the opposite sidewall extending from the entrance edge to the outside edge, a first corner is rounded between the first sidewall and the backwall, a second corner is rounded between the opposite sidewall and the backwall.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion. As will be understood by those skilled in the art with the benefit of this disclosure, elements and arrangements of the various figures can be used together and in configurations not specifically illustrated without departing from the scope of this disclosure.

FIG. 1A is a sectional view of a prior art gate valve with the gate in a partially opened position creating a small flow passage through the gate bore.

FIG. 1B is a top view of the prior art gate valve of FIG. 1A illustrating the small flow path with the gate is the partially open position.

FIG. 1C is an expanded view of the gate position in FIG. 1A.

FIG. 2A is a sectional view of an example gate valve and gate according to one or more aspects of the disclosure.

FIG. 2B is a top view of the example gate valve of FIG. 2A illustrating a small flow path with the gate in the partially open position.

FIG. 2C is an expanded view of the gate position shown in FIG. 2A.

FIG. 3 illustrates an example of a gate for reducing erosion according to one or more aspects of the disclosure.

FIG. 4A schematically illustrates an intersection of gate bore with three positions of an output bore of a gate valve according to one or more aspects of the disclosure.

FIG. 4B schematically illustrates example details of an erosion mitigating gate for a gate valve according to one or more aspects of the disclosure.

FIG. 5A is a view along the line I-I of FIG. 4B.

FIG. 5B is a view along the line II-II of FIG. 4B.

FIG. 6 illustrates another example of a gate for reducing erosion according to one or more aspects of the disclosure.

FIG. 7 illustrates a novel seal arrangement at a stem and bonnet of a gate valve according to one or more aspects of the disclosure.

FIG. 8 is a sectional view of the bonnet described with reference to FIG. 7 according to one or more aspects of the disclosure.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

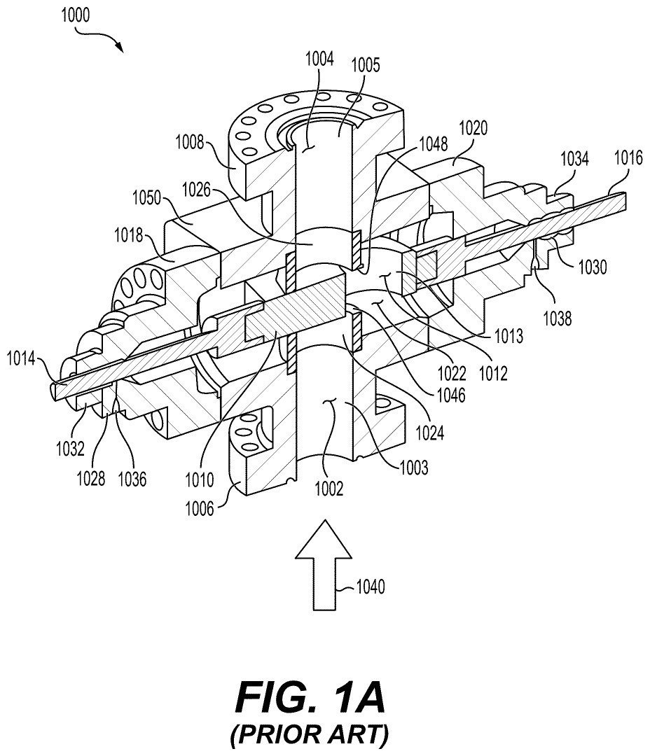

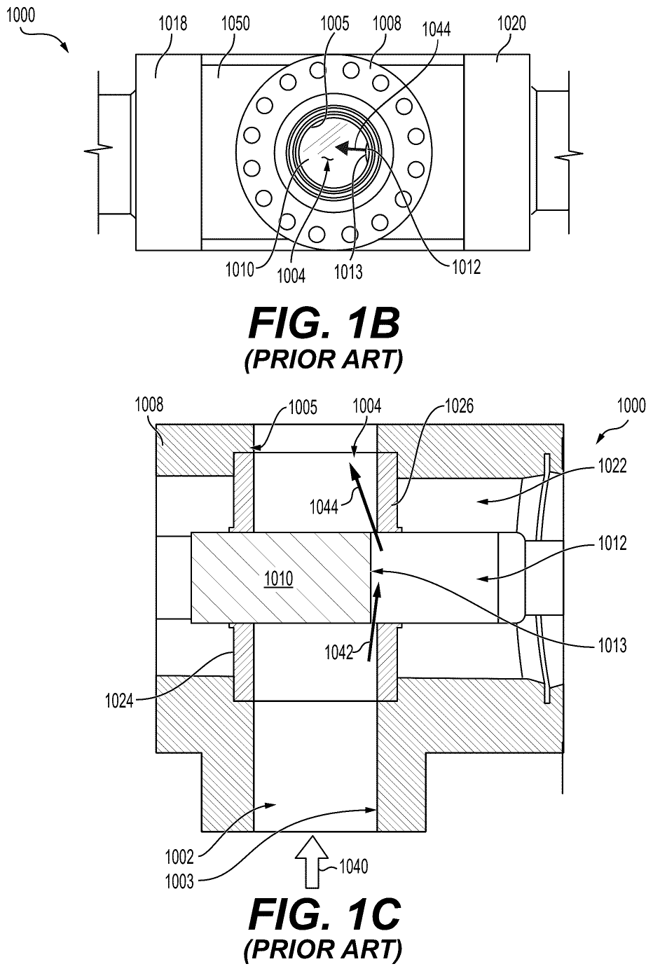

FIG. 1A is a sectional illustration of a prior art gate valve 1000 used to control the flow of innumerable fluids, including abrasive fluids such as frack fluids. In most prior art embodiments, gate valves are usually operated in their fully opened or fully closed states. When a gate valve is in the fully opened condition, it permits the passage of fluids within gate valve 1000 from an input bore 1002 to an output bore 1004, which are defined by their sides 1003, 1005. External flanges 1006, 1008 are used to attach the gate valve to conduit such as tubular pipe, manifolds, and various trees known to those ordinarily skilled in the art. Arrow 1040 indicates the direction of flow of the fluids through the gate valve from upstream to downstream.

Gate 1010 crosses input and output bores 1002, 1004. In a first position gate 1010 will block bores 1002, 1004 and prevent the flow of fluids. In a second position, a path may be aligned with bores 1002, 1004 to permit the flow of fluids through bores 1002, 1004. This path through gate 1010 is defined by gate bore 1012, which is defined by its sides 1013. Gate bore 1012 is usually cylindrical and may have the same or similar diameter and cross-sectional area as input and output bores 1002, 1004. Sides 1013 of a gate bore 1012 may have sharp or lightly relieved edges where bore 1012 meets the upper and lower surfaces of gate 1010.

Gate 1010 may be moved between the opened and closed positions by pulling or pushing of stems 1014, 1016, which extend through bonnets 1018, 1020 and attach to either end of gate 1010. Moving stems 1014, 1016 may be accomplished in any number of ways known to those skilled in the art such as, but not limited to: threads, gears, actuators, and solenoids.

Stems 1014, 1016 may be attached to extended threaded members and a wheel with matching threads. Screwing a wheel onto a threaded extension of stem 1014 will result in moving the gate towards bonnet 1018 as the face of the wheel abuts and spins against a yoke. Moving gate 1010 towards bonnet 1018 will continue as long as the wheel is spun along the threads of the extension to stem 1014 until the shoulder of stem 1014 is seated within bonnet 1018 thus preventing any further movement. The wheel may be manually turned which can result in an irregular movement of gate 1010 while the worker adjusts their grip on the wheel. Automating the spinning of the wheel to draw either stem 1014, 1016 in a direction may result in a smoother movement and may produce a faster movement as well.

Prior art valve 1000 is commonly known as a double acting valve since it has bonnets and stems on both sides. Those of ordinary skill in the art will recognize the principles disclosed herein is applicable to other valves including, but not limited to, single acting gate valves where there is usually a single bonnet and a stem on one side of the gate.

The fit between stems 1014, 1016 and respective bonnets 1018, 1020 are designed to be very tightly fitting to prevent any fluids from plenum 1022 from leaking out. Notwithstanding a tight fit, packing such as is known to those familiar with the art may also be used to prevent leaking. Such packing may be retained within stuffing boxes, packing glands, or even within circumferential channels within the bonnet bores. Gate valve 1000 depicts packing 1028, 1030 sealing the fit between the stems 1014, 1016 and their respective bonnets 1018, 1020. Packing 1028, 1030 is retained in gate valve 1000 with exemplary stuffing boxes 1032, 1034. Those ordinarily skilled in the art will know of other ways to retain packing within a gland, such as but not limited to an internal gland nut.

Lubrication may also be desired to allow smooth operation of stems 1014, 1016 moving within bonnets 1018, 1020. As such, lubrication ports 1036, 1038 are arranged on bonnets 1018, 1020. These lubrication ports 1036, 1038 may be used to inject grease into the tolerance between the stem and the bonnet.

Gate bore 1012 is shown in FIG. 1A in a position that partially overlaps the cylindrical column formed by bores 1002, 1004. This partial opening, representative of a valve in a condition of being slightly opened or nearly closed, restricts the flow of fluids entering input bore 1002, slowing the overall volumetric flow rate of the fluids leaving gate valve 1000 through output bore 1004. Also, while gate 1010 is in this position the fluids from input bore 1002 are free to enter interior plenum 1022.

The gate may be configured with surfaces and edges that mate with the surfaces and edges of the body of the valve or that mate on the surface of seats 1024, 1026. In such valves, a seal may be formed when upstream pressure on the gate presses the gate against downstream sealing surfaces on the surface of seat 1026. The seal may be broken when the gate is moved to allow a flow of fluids from input bore 1002 to output bore 1004. That is to say that without the pressure of the fluid being exerted evenly on a surface of the gate, fluid may enter output bore 1004 between a gap between seat 1026 and output bore 1004. As gate 1010 nears a nearly closed, or nearly open state as shown in FIG. 1A, the pressure on the gate from fluid in input bore 1002 will press gate 1010 towards the surface of seat 1026. The pressure from the fluid in input bore 1002 will continue to press gate 1010 so that there is less of a gap between gate 1010 and seat 1026.

Gate seats 1024, 1026 may be deployed to seal any gaps between gate 1010 and input and output bores 1002, 1004. Similar to a valve body that has sealing surfaces, a seal may be formed when upstream pressure forces gate 1010 against sealing surface 1048 of upstream seat 1026. Seats 1024, 1026 may have a lip or edge around face 1046, 1048 that contacts gate 1010.

Most prior art gate valves incorporate replaceable gate seals. As shown, gate seats 1024, 1026 may be configured to securely fit within a recess adjoining the input and output bores 1002, 1004 thereby creating a seal.

FIG. 1B illustrates a top view of a prior art gate valve 1000 and FIG. 1C is a sectional view of the throughbore portion of prior art gate valve 1000. Gate 1010 is illustrated in the same position in FIGS. 1A, 1B, and 1C with gate bore 1012 positioned to provide a small gate path between inlet bore 1002 and outlet bore 1004.

As may be seen best in FIG. 1B the flow path opens when an edge 1013 of gate bore 1012 vertically aligns, or intersects, sides 1003, 1005 of input and output bores 1002, 1004. This will start with a point and grow as the arcs of the circumferences of the bores continue to increase their overlap.

In operation gate valve 1000 may be opened and closed many times. As gate 1010 nears the closed position, the flow path will be only partially available for the fluid to pass. In this position, a nozzle effect may be created, projecting a stream and anything within that stream at higher velocities and in a concentrated area of direction. Any particulates in the flow have the potential to erode critical sealing areas and potentially wash out other critical areas of the valve.

The position of gate 1010 within prior art gate valve 1000 is typical of when gate 1010 is being opened or closed. In either case, gate bore 1012 will have only a small overlap with input and output bores 1002, 1004. With the flow port open very slightly, fluid entering the valve through input bore 1002 will be restricted as it enters and passes through gate bore 1012. The fluid will again be restricted as it leaves gate bore 1012 and enters output bore 1004.

Fluid flow restrictions generally result in a pressure drop and in a decreased volumetric flow rate as compared with an unrestricted fluid flow. However, the velocity of the fluids, along with any carried particulate matter that pass through those orifices may be greatly increased going through a restriction.

Fluid passing from input bore 1002 through the restricted passage 1012 opened from the overlap with gate bore 1012 produces a jet or stream 1042 of fluid that has been seen to have a high flow velocity. Jet 1042 will be carried past gate port 1012 and through plenum 1022 to impinge on the inner surface of prior art gate valve 1000. Any carried particles have a highly abrasive impact that has been known to erode the inside surfaces of gate valves and other flow control devices.

Similarly, fluid passing from gate bore 1012 to outlet bore 1004 produces a jet or stream 1044 with a high velocity and direction that may impinge on the surfaces of the valve body, such as output bore seat 1026 and output bore 1004. The impingement of a fluid on a part within a valve by itself may have an erosive characteristic. However, this erosive characteristic is exacerbated by any particulate matter that is within the fluid, such as particles in jet 1044. One example of such a particulate within a liquid fluid is proppant within hydraulic fracturing fluid as used within oil and gas wells. An example of such a particulate within a gas fluid is entrained sand. The particulate matter and streams 1042, 1044 can impact and erode the exposed seal faces 1046, 1048 when they are not in contact with gate 1010.

The jet qualities and erosion impacts described will be further exacerbated as the flow port is further closed, resulting in only a very small area. This jet is often described as a point of flow. Under rapid and constant movement of gate 1010 toward the closed position, such as if a motor is driving stems 1014, 1016, the point of flow may be brief but will still cause erosion of parts. However, if the valve is being manually operated, this point of flow may occur at a time when a worker is changing their grip on the wheel, resulting in a long-lasting point of flow having even more deleterious results.

It has been seen that an area around the seam of the abutment between gate seat 1026 and output bore 1004 in a direction directly across from the orifice produced from the overlap of gate bore 1012 and gate seat 1026 often bears the brunt of the erosion from stream 1044. That is to say as the gate moves toward the closed position, the flow vector changes: the velocity of the fluid along with any particulate matter is increased, and the direction of flow moves downward. In a first state with the flow port completely open, the flow vector is the velocity of the fluid in the downstream direction. As the gate moves toward the closed position, the flow vector changes in that the fluid velocity increases and the direction becomes angled away from the center of the downstream direction in the direction away from the side of the partial opening. In FIG. 1C, the flow vector will match jet 1044 as the fluid moves from gate bore 1012 into output bore 1004. The flow vector will have a focus that will narrow as the flow path is closed.

The areas of greatest concern regarding degradation of the overall integrity of the gate valve 1000 are sealing faces 1046, 1048 (FIG. 1A) on the seat of the seat-to-gate location, and the seat seal located between seat 1026 and output bore 1004 of valve body 1050.

As the flow vector is directed toward the area above seat 1026, material from surface 1005 of output bore 1004 will be eroded. With the closing of the gate, the flow vector will move downward to impact an area around the seam between surface 1005 and seat 1026. As the gate is further closed, the flow vector will continue to move downward and impinge a focused area on seat 1026.

Refurbishing a valve after use will require an assessment of the degradation of the parts from the erosive effects of the flow vector of the fluid and particulate matter. Seat 1026 may be replaced if too much material has been worn away. However, replacing the entire valve body 1050 is costly so efforts are usually made to repair damaged sections. This may include adding filler material such as melted metals or alloys to fill eroded spots. The cooled and solidified filler will likely need to be ground to match the surface of the bore, and the body will need to be milled to accept a new seat and seat seal. These procedures take time and are costly. Nonetheless, it is easier and less expensive to repair an area in the body in the general flow path compared to repairing the socket into which the seal resides.

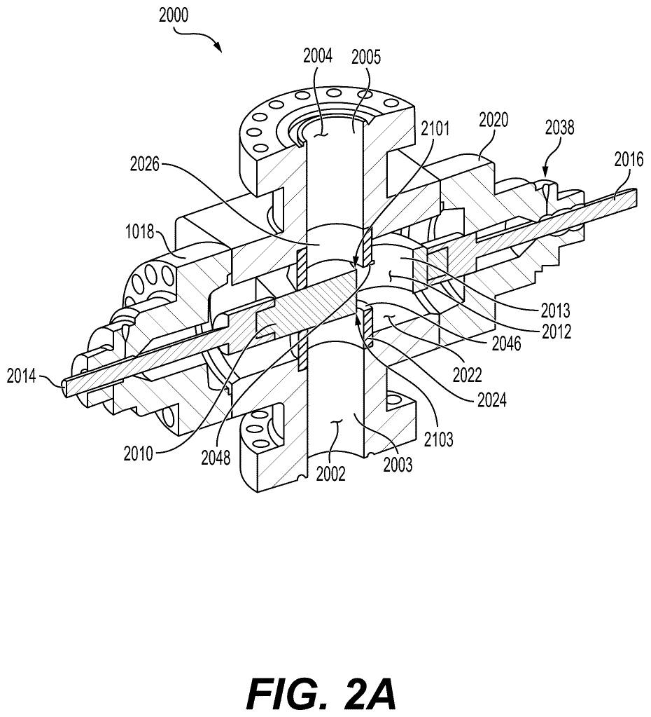

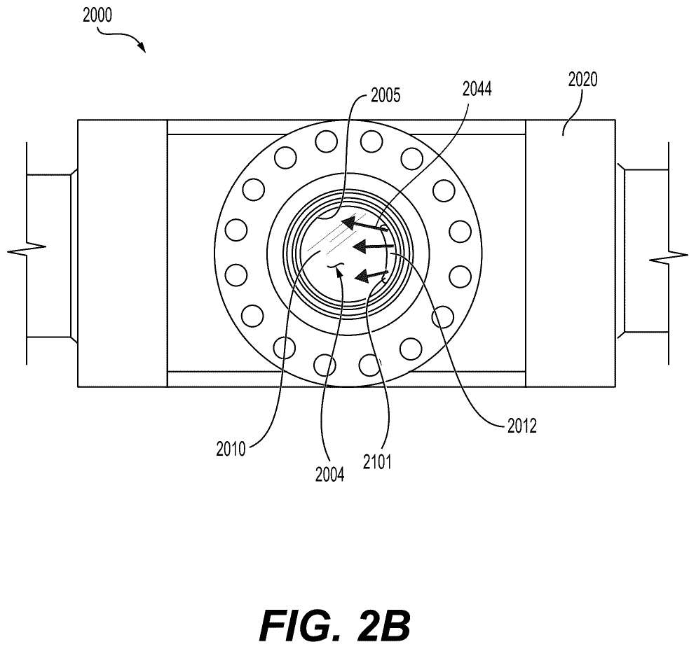

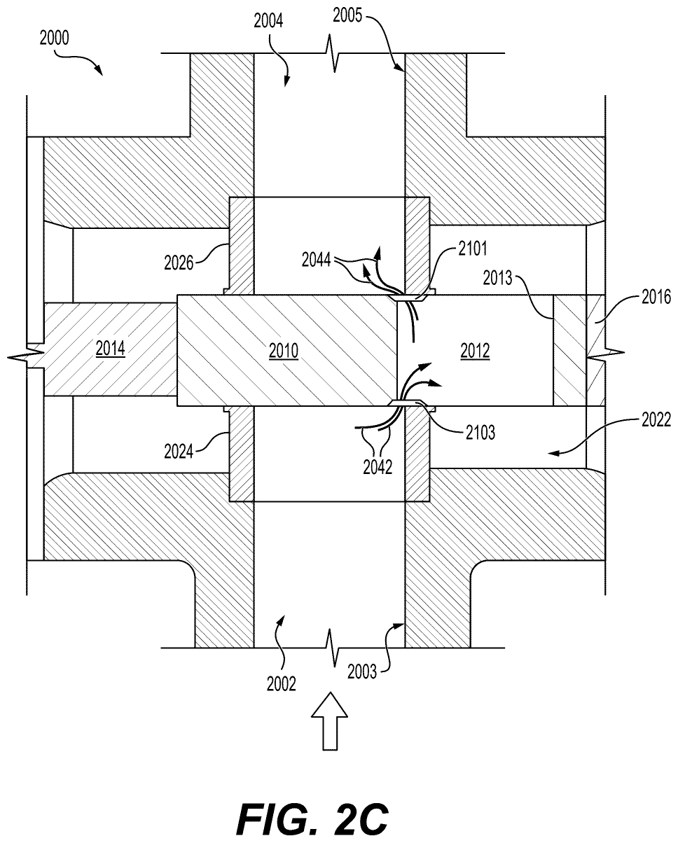

FIG. 2A is a sectional of an exemplary gate valve 2000 in accordance with aspects this disclosure. Gate 2010 has flow relief pockets 2101, 2103 formed in edges 2013 of gate bore 2012 nearest the portion of gate bore 2012 that first intersects the edges of gate seats 2024, 2026 when opening or closing gate 2010. Pockets 2101, 2103 are structurally configured in shape and orientation to change the flow vector on opening or closing as compared to the prior art gate valves. Each pocket 2101, 2103 changes the flow vector by lowering the flow velocity (e.g., flow velocity) and/or changing the flow direction (e.g., average direction) of the steam by preventing or reducing a point of flow (e.g., nozzle effect) immediately prior to opening or closing as will be described. As will be understood from this disclosure, reducing the velocity of flow and/or changing the direction of flow can reduce or prevent erosion of the gate valve or, alternately, re-direct erosive damage to a portion of the gate valve more easily repaired on refurbishment.

Pocket 2101 may be seen in more detail in FIG. 2B, which illustrates a top view of exemplary gate valve 2000, and in FIG. 2C, which is a sectional illustration of exemplary gate valve 2000 immediately prior to the fully closed state. In these illustrations, the flow path 2012 is like that shown in FIGS. 1B and 1C in that the flow path through gate valve 2000 is defined by the intersections of side 2013 of gate port 2012 and sides 2003, 2005 of input and output bores 2002, 2004. As illustrated in FIGS. 2A-2C, gate 2010 is mostly closed and moving the gate 2010 toward bonnet 2020 will further close the gate and stop the flow path.

When gate 2010 starts with the flow path closed and moves towards the fully opened state, pockets 2101, 2103 will open the flow path along their individual leading edges that intersect the edges of gate seats 2024, 2026. These openings 2101, 2103 will not form a point opening, but rather are configured to form a line opening, such as an arc, of flow. Thus, rather than forming a point nozzle creating a concentrated jet or point of a flow, the opening or closing flows 2042, 2044 (FIGS. 2B, 2C) will be broader and more diffuse, e.g. flared, across the opening, thereby having a lower velocity than that through a point opening.

As can be understood from FIG. 2C, the first intersection of side 2013 of gate bore 2012 and sides 2003, 2005 of inlet and outlet bores 2002, 2004 occurs after a flow path has just begun to be opened. The flow path will open before the first intersection of the bores because the pockets 2101, 2103 have open recesses in gate 2010 that break the seal between faces 2046, 2048 of gate seals 2024, 2026 and gate 2010 before the intersection occurs.

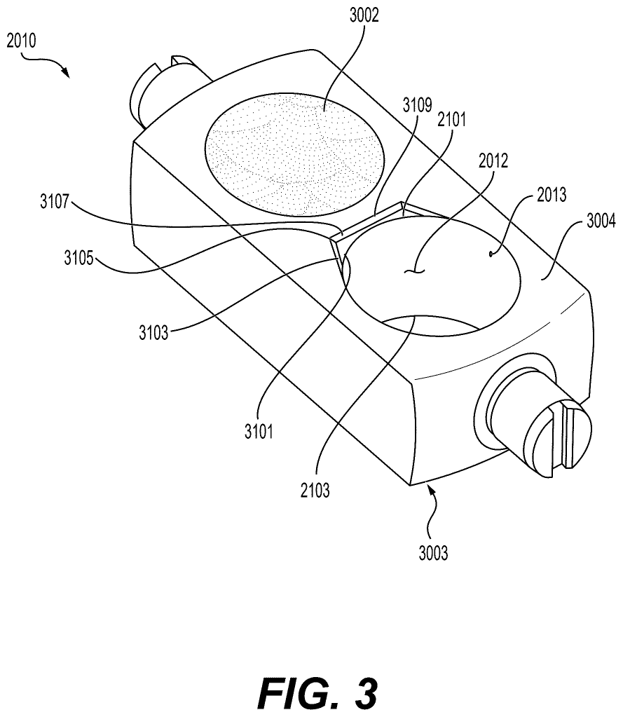

FIG. 3 is a perspective illustration of a gate 2010 in accordance with aspects of the disclosure. This figure provides a more detailed illustration of gate 2010 in FIG. 2A. Gate 2010 has an upper surface 3004 and a lower surface 3003. The shaded circle 3002 indicates where gate 2010 would be seen by an observer looking down on the gate through output bore 2004 if the gate were in the fully closed state.

Upper flow relief pocket 2101 may be formed by removing, such ad by machining, material from upper surface 3004 of gate 2010. One of many processes that may be envisioned by those ordinarily skilled in the art would be to mill pocket 2101 from a blank either before or after gate bore 2012 is formed.

In this exemplary embodiment, lower pocket 2103 may be configured similar to the upper pocket 2101. It will be appreciated by those skilled in the art with benefit of this disclosure, that different configurations of the inlet side pocket and outlet side pocket may be implemented based on the requirements or desired results for a particular gate valve. In some embodiments, gate 2010 may have only an outlet side pocket or an inlet side pocket.

Pocket 2101 may have a bottom surface 3101 recessed below top surface of 3004 of gate 2010. Pocket 2101 may have rounded sides 3103 and a rounded back 3107 with similarly rounded corner 3105 where sides 3103 meet back 3107.

Back 3107 may be curved along an arc 3109. Arc 3109 may have a radius equal to the radius of the aperture of input and output bores 2002, 2004, and seats 2024, 2026. It is contemplated that computational fluid dynamics may be used to aid and/or optimize the precise design configuration of flow relief pockets for any given design of gate valve.

Referring to FIG. 2A, when gate 2010 is moved from the fully closed position toward the open position, shaded area 3002 of FIG. 3 will appear to move toward gate bore 2012. At one point in this movement, an edge of shaded area 3002 will intersect arc 3109 of pocket 2101 thereby opening a flow path (bore 2012 open to outlet bore 2004). This overlap arc formed during operation of valve 2000 has a length and is therefore larger than the point that would occur upon opening a prior art valve 1000. For additional movement of gate 2010 in opening flow area of valve 2000, a much larger gap will be formed allowing greater volumetric flow than what would equivalently happen using prior art gate 1010.

Since back 3107, sides 3103, and corners 3105 of pocket 2101 are curved, the fluids entering output bore 2004 will be directed along an upward path following the curves of these components. This has the effect of dispersing the fluid generally upward as seen by stream 2044 in FIG. 2C, rather than being jetted toward a specific area of the valve illustrated by jet 1044 in FIG. 1C.

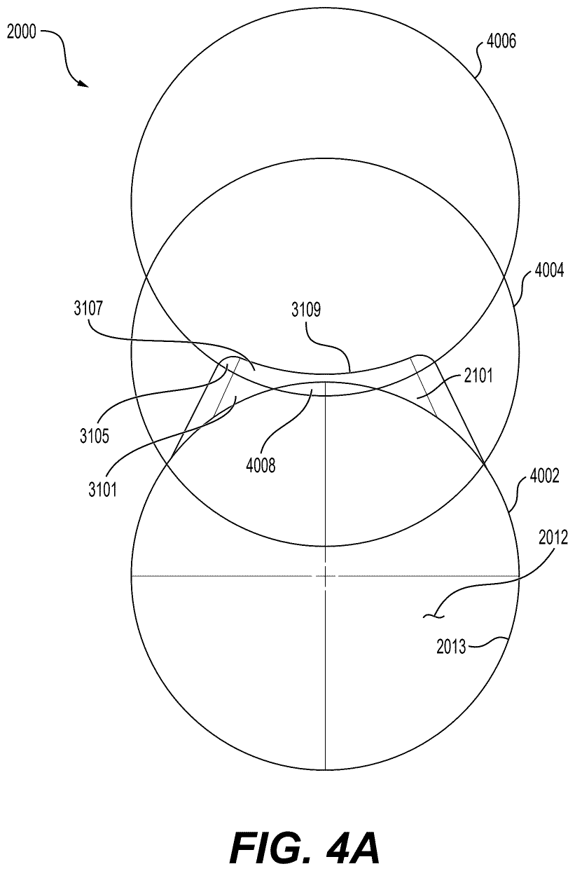

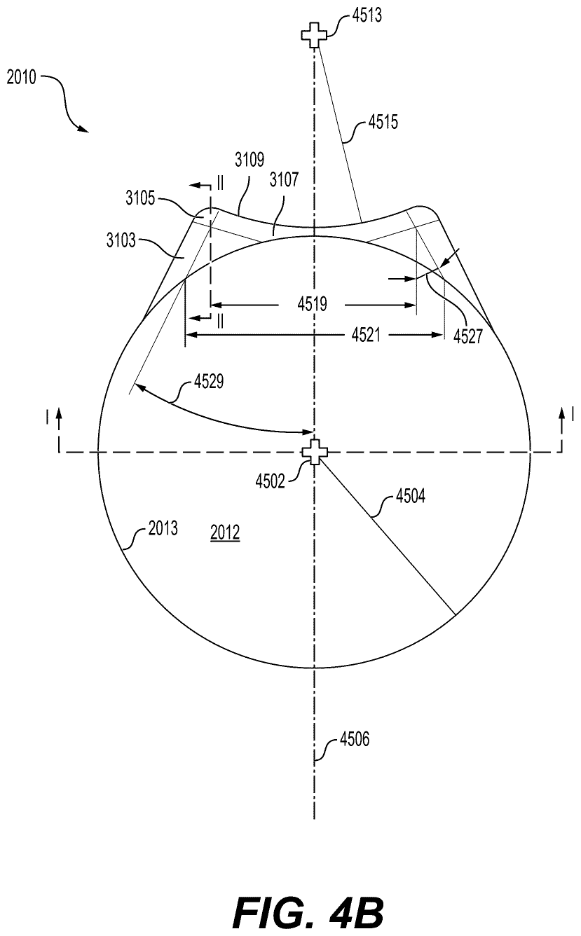

FIG. 4A illustrates the intersection of gate bore 2012 with three positions of output bore 2004 during the operation of closing valve 2000. A first position 4002 is where the output bore entirely overlaps gate bore 2012, thus flow port 2012 is fully open. Those of ordinary skill in the art with benefit of this disclosure will understand that face 2048 (FIG. 2A) of output seat 2026 will need to cover pocket 2101 so that fluids do not leak into plenum 2022.

A second position 4004 is where gate bore 2012 is being withdrawn from being directly under output bore 2004. Face 2048 of output seat 2026, which corresponds with circle 4004, no longer covers pocket 2101. In position 4004 the volumetric flow is less than the volumetric flow of first position 4002 due to the decreased overlap. With this restriction in the flow path, the velocity of fluids 2044 (FIG. 2C) entering output bore 2004 will be increased, assuming constant or nearly constant pressure. However, the direction of fluids 2044 traveling into output bore 2004 will still be primarily upward. The structure of the pocket will have little influence on the direction of the fluid in position 4004. In second position 4004 fluids may flow from input bore 2002, bypass gate bore 2012 by going through plenum 2022, and pass to output bore 2004.

A third position 4006 is where gate bore 2012 has been withdrawn even further from being directly under output bore 2004. In this condition, seal face 2048 of output seat 2026 covers parts of pocket 2101. The fluid moving vertically along gate bore 2012 may be considered to be in three portions. A first portion will continue to move vertically into output bore 2004 through opening 4008. A second portion will be deflected by seal face 2048 and move outward into plenum 2022. A third portion will be deflected by seat seal face 2048 and move into pocket 2101. The fluid of the third portion will travel substantially parallel to the lower surface of pocket 2101 until it is deflected along the path of corners 3105 or back 3107 of pocket 2101.

A relatively large portion of the fluid entering output bore 2004 will have transitioned from moving vertically up input bore 2002, then horizontally across surface 3101, and vertically up back 3107 of pocket 2101. The deflection from back 3107 will change the direction of the overall fluid to be more vertical as it rises through output bore 2004. This will prevent or reduce a focused flow vector, such as a point of flow, and will distribute the fluid along an arc. Jets 2044 as seen in FIG. 2C will not impinge upon areas of output bore 2004 across opening 4008 (FIG. 4A) but will turbulently flow generally upward.

Since the final stages of the opening of FIG. 4A will have an opening defined by an arc rather than of the point in the prior art valve 1000, the volume of fluids moving into output bore 2004 will be greater compared to the volume of fluid moving into output bore 1004. This increased volume going through the flow port will result in a relative decrease in velocity. From that, the flow vector of the direction and velocity of the fluid and accompanying particles impinging seal 2026 or surface 2005 of output bore 2004 may have little if any erosive effect on the critical areas of the downstream components of the gate valve.

As gate 2010 continues to move to the closed position, the edge of output seal 2026, which is vertically below output bore 2004, will pass intersection with pocket edge 3109 thus stopping the flow of fluids through the gate path.

FIG. 4B illustrates example details of a gate 2010 that may be used in, e.g., a 7 1/16 inch gate valve. The dimensions provided in this disclosure are not limiting, rather, they are provided as an example and further understanding. These dimensions may be scaled or otherwise modified to other gate valves without departing from the spirit of this disclosure.

The radius 4504 of gate bore 2012 may be about 3 to 4 inches and may be the same as the radius of the input and output bores. Gate bore 2012 may have an axis of symmetry 4506 through the center 4502 of the gate bore 2012. Gate 2010 may have an overall length of about 19 inches. Sides 3103 and back 3107 of pocket 2101 may be curved with about a 0.30 inch radius. The transition from sides 3103 to back 3107 along corners 3105 may have a radius of about 0.06 inches.

Arc 3109 may have a radius 4515, which may be the same length as radius 4504 of the gate bore 2012, or a different length. Illustrated arc 3109 is convex relative to central axis 4502. The length of the line from gate bore center 4502 to point 4513 may be about 8 inches.

An outer distance 4519 between radii for corners 3105 may be about 3½ inches. An inner distance 4521 (arcuate portion of bore 2012) between the leading edges of sides 3103 where they meet gate bore 2012 (at the entrance edge) may be about 4½ inches. The angle 4527 from a line parallel to symmetry line 4506 to the edge of sides 3103 may be about 26 degrees. Similarly, the angle 4529 may be about 26 degrees.

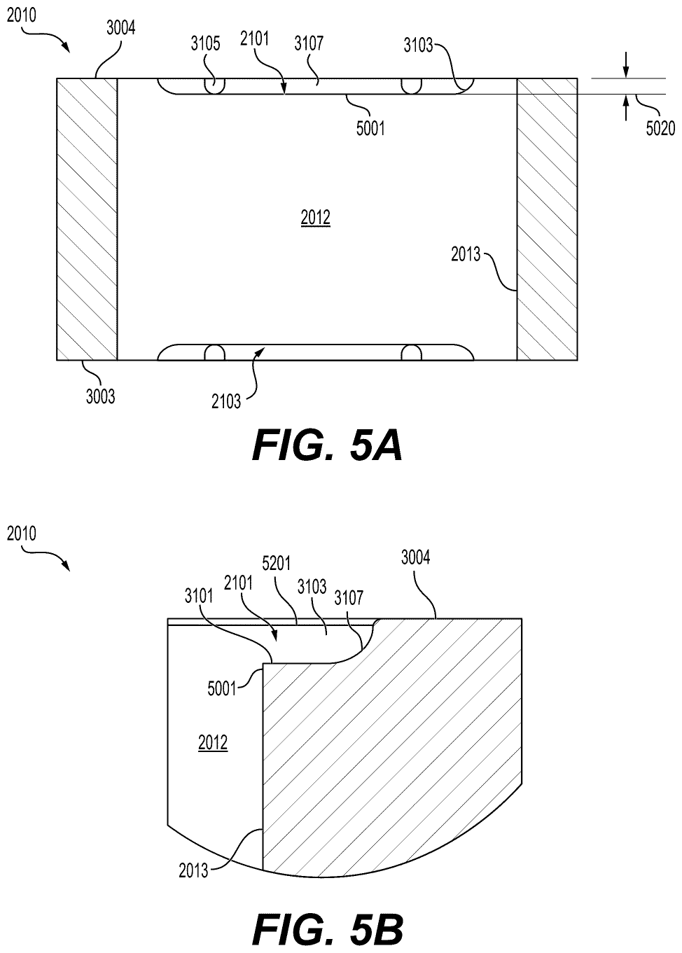

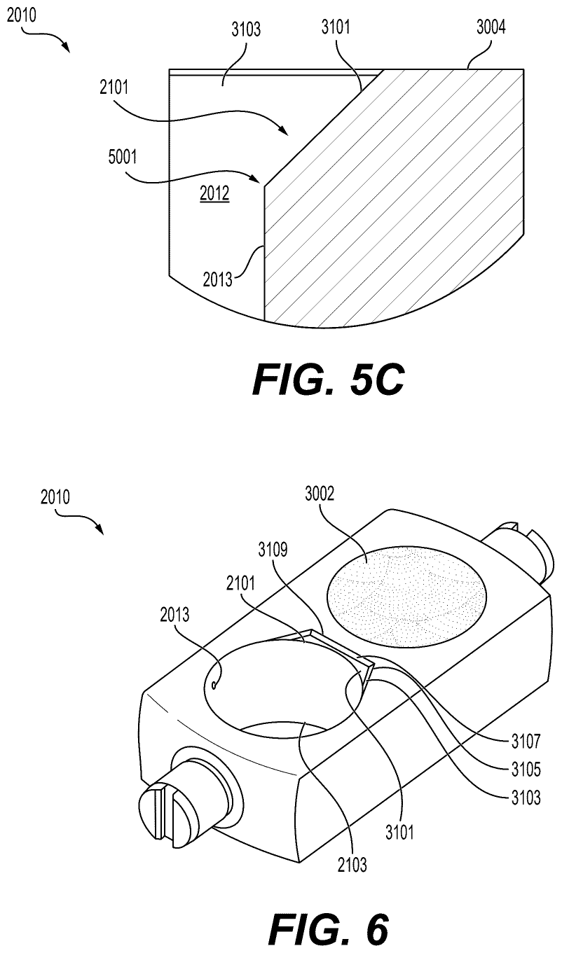

FIG. 5A illustrates a gate 2010 along the line I-I of FIG. 4B according to aspects of the disclosure. In this example, pocket 2103 has the same dimensions as pocket 2101 but is on the underside of gate 2010. Pocket 2101 has an entrance edge 5001 where side 2013 of gate bore 2012 transitions to pocket 2101 (surface 3101). Pocket 2103 may have a depth 5020 from surface 3004 to edge 5001. An example distance 5020 is 0.267 inches.

FIG. 5B is a view along the line II-II of FIG. 4B revealing side 3103 of pocket 2101. A chamfer 5201 is shown between side 3103 and backwall 3107 and top surface 3004 of gate 2010. Entrance edge 5001 is a generally 90-degree transition from vertical cylindrical wall 2013 to surface 3101 of pocket 2101. Transition of edge 5001 may be eased between surface 3101 of pocket 2101 and gate bore 2012.

As described elsewhere, when a flow of fluid has a mostly horizontal direction coming into pocket 2101, it will hit side 3103 and be diverted upward. The eased transition of edge 5001 and chamfer 5201 may reduce eddies that may form from edge effects of fluids traversing edges.

FIG. 5C is another example of gate 2010 along the same view as FIG. 5B. In this embodiment, pocket 2101 is an angled pocket. Fluids moving vertically up the sides 2013 of gate bore 2012 and deflected by seal face 2048 (FIG. 2A) of output seal 2026 will angle outward following contour of simplified pocket 2101. In this example, transition edge 5001 from vertical wall 2013 to surface 3101 of pocket 2101 is an acute angle relative to vertical. In this example, bottom surface 3101

FIG. 6 illustrates an example gate 2010 utilizing an angled pocket 2101 such as illustrated in FIG. 5C. Similar to gate 2010 illustrated in FIG. 3, gate 2010 has a shaded circle 3002 where gate 2010 would be seen by an observer looking down on the gate through the output bore of the gate valve if the gate were in the fully closed state. Angled sides 3103 extend to back edge 3109, which in this example is straight for pockets 2101 and 2103.

Rather than having back 3107 and sides 3103 meet at a line, a shaped corner 3105 may be formed. While a line formed from the intersection of back 3107 and side 2013 may create a point of flow, a shaped corner 3105 will provide additional direction-changing characteristics to the fluids entering the output bore.

In this embodiment, a flow path will open when pocket 2101 is moved away from under a face of a seal. However, pocket 2101 will still divert the flow from a horizontal flow to a somewhat vertical flow as it leaves the pocket 2101 along the contour of corner 3105. In an embodiment, the shape may be a flat surface adjoining back 3107, sides 3103, and surface 3101. In another embodiment, shaped corner 3105 may be a concave shape.

Since outside edge 3109 is straight across, the final stages of closure of gate 2010 will result in two flows: one at each curved corner 3105 of pocket 2101. The resulting flow vectors from these will be directed generally upward because the fluid will be deflected upward by corners 3105, and the velocities of each of these two flow vectors will be half of the velocity of a single point flow. These changes to the flow vector of the fluids entering output bore 2004 will greatly reduce the erosive effect of the particulate laden fluid stream.

Rather than having a single outside edge 3109 along back 3107 of pocket 2101 an arrangement of multiple edges may be formed to create additional corners thus creating additional flow vectors when the gate is closed or opened. Additionally, the multiple edges need not all be straight, but some may be formed in an arc. This may have an advantage of eliminating some of the point flows created.

As mentioned elsewhere in this disclosure, gate valves and other apparatuses for controlling the flow of fluids may be operated many times during their active duty. Each time a prior art gate valve is operated under the conditions described in this disclosure, some of the parts may be eroded. The particularly vulnerable areas such as the sealing surface on the seat of the seat-to-gate location, and the seat seal located between the seat and the valve body must not be allowed to erode, or wash out, to the point of failure. In most operations, maintenance plans and schedules are kept ensuring that preventive maintenance occurs well before any damage could become critical to the operation of the valve or other flow control device.

When a valve does need maintenance, it is taken out of service. Frequently it will be taken to a refurbishment shop. At the shop, it may be disassembled where the pieces can be inspected for wear, corrosion, or serviceability. In most cases, the body and bonnets are reused. In the case of exemplary gate valve 2000, gate 2010 may be detached from stems 2014, 2016 and removed. Seals 2024, 2026 may be removed and reused if they are found to be serviceable.

With gate 2010 removed, pockets 2101, 2103 may be inspected for abnormal wear or erosion. If gate 2010 is found to be serviceable, it may be reinstalled in the gate valve as it was removed, with the top surface again on the top, or it may be reversed with the top surface now on the bottom.

In some cases, different pockets may be formed on the same gate. One of many examples of this would be to place a pocket as shown in FIG. 5A on one side of the gate, and a pocket as shown in FIG. 5B on the other side of the gate. In another of many examples, a pocket as shown in FIG. 3 may be configured on one side of the gate, while a pocket as shown in FIG. 6 may be configured on the other side. In yet another of many examples, one side of a gate may be configured with a pocket as disclosed herein, while the other side may be left with straight edges or with straight edges with a relief or chamfer.

Using a gate with different pockets configured on each side may be advantageous for a relatively rapid refurbishment of the gate valve. As an example, a gate may be used with one type of pocket configured on the downstream side of the gate. In this, it may be known where the flow vectors will occur with that type of pocket. After some use, it may be determined that erosion of the sealing faces on the seat of the seat-to-gate location, and the seat seal located between the seal and the output bore of the valve body has occurred but not to a point where the valve is susceptible to failure. In that state, the gate may be reversed such that the gate pocket now on the downstream side of the valve will produce a different flow vector pattern. New erosion will occur in different areas on the downstream side of the valve, thus delaying the need for extensive refurbishment.

Another area that may be damaged from contact with particulate matter within fluids traversing a valve or other flow control device are the stems and bonnets. With reference to prior art gate valve 1000 in FIG. 1A, stems 1014, 1016 are not always seated within their respective bonnets 1018, 1020. In most cases, sufficient tolerances may be left between the stems and bonnets to allow fluid containing particulate matter to be flushed from the bonnets when the stems are drawn into them. However, if an abundance of particulate matter settles in the bonnets, or if an insufficient gap is left, flushing fluids with particulates may erode or score the surfaces of the stems and bonnets as the stems are moved through the bonnets. In some cases, the shoulder of a stem may act as a piston to drive fluids and particulate matter deeper into a bonnet. This may force fluids and particulate matter to enter the packing gland and the lubrication port. As described elsewhere in this disclosure, parts that are no longer serviceable will have to be replaced during refurbishment. In some cases, the scoring or erosion of the bonnet or the stems may allow fluids to leak into the packing gland or even through the packing gland to leak outside of the valve.

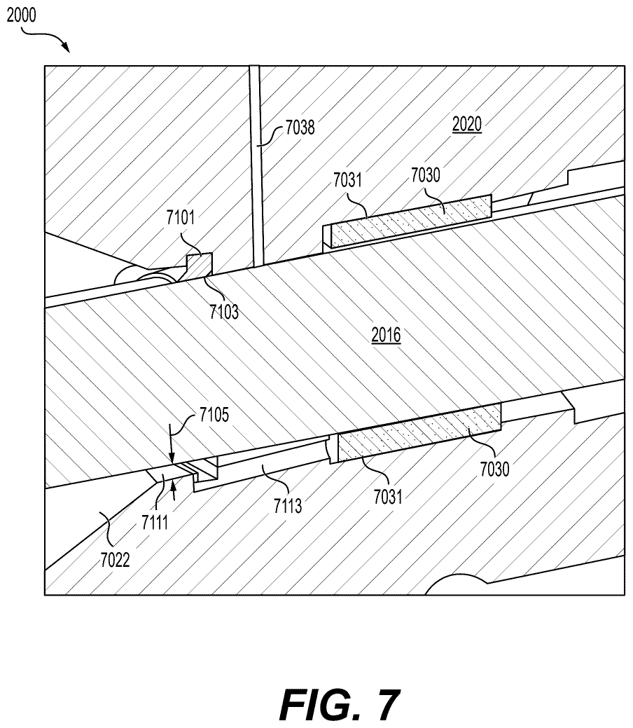

FIG. 7 depicts a novel seal arrangement at stem 2016 and bonnet 2020 of a gate valve 2000. Packing 7030 extends circumferentially around stem 2016 within packing gland 7031. Lubrication channel 7038 extends to a lubrication port 2038 (FIG. 2A) on the surface of bonnet 2020. As noted, the packing may be retained using a stuffing box or other methods.

A circumferential channel 7101 may be configured in the interior of bonnet 2020 where a wiper 7103 may be installed. An area 7111 with a gap 7105 between stem 2016 and bonnet 2020 has been configured. Wiper 7103 may be of any conventional material and configuration known to those sufficiently skilled in the art.

A pressure channel or weep hole 7113 may also be configured to allow any fluids within the packing gland 7031, containing the packing 7030, to be expelled outside of the circumferential channel 7101 containing wiper 7103 through the gap 7105 into the plenum 7022 of the gate valve. This weep hole 7113 may prevent particulate matter from being forced into packing 7030 due to any pressure from the gate valve. Such pressure may come from pressure changes within plenum 7022 of the valve or during the movement of the stem.

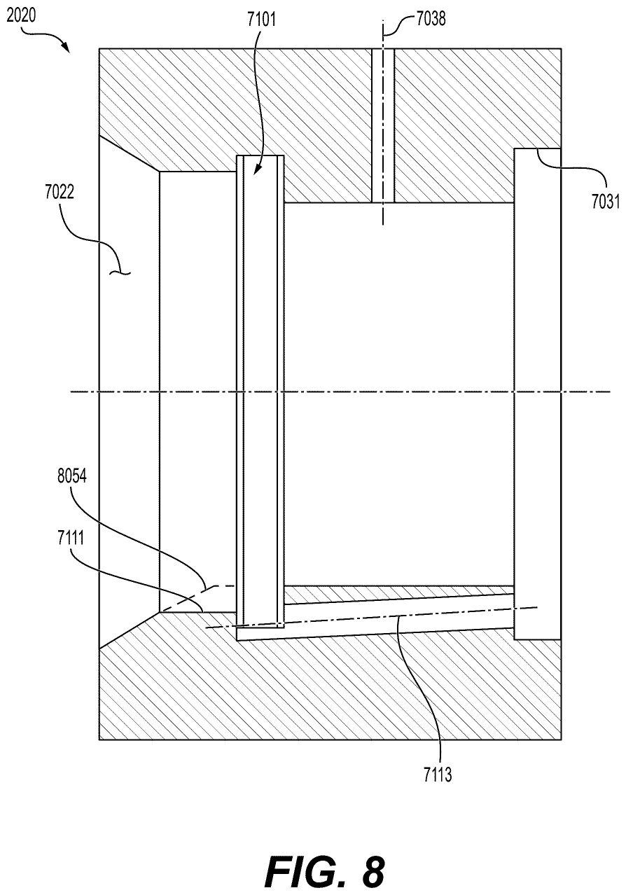

FIG. 8 is a sectional view of a bonnet 2020 and is described with reference to FIG. 7. Circumferential channel 7101 may is shown with eased or chamfered edges and may be used to retain wiper seal 7103. Line 8054 shows where the prior art surface of bonnet 2020 would be without circumferential channel 7101 and the area 7111.

In one of many embodiments, wiper seal 7103 will keep out particulate matter but will not buckle or deform due to a pressure difference between each side of wiper seal 7103. In this embodiment, weep hole 7113 may be used to equalize any pressure differences between the interior of bonnet 2020 and packing gland 7031.

In another embodiment, a weep hole may not be needed if wiper seal 7103 has perforations that allow small amounts of fluid to transfer through wiper seal 7103. In this embodiment, the perforations may be sized relative to the expected particulate matter such that the perforations allow fluid to pass but do not allow particulate matter. In another embodiment, wiper seal 7103 may be made of a mesh or other material that allows fluid to pass without permitting particulate matter to enter packing gland 7031.

In another embodiment, a buckling or deforming of the wiper seal may be desirable if the bucking permits the equalization of pressure but does not allow the passage of any particulate matter.

In another embodiment, the wiper seal may have a bladder formed either inside of the wiper seal or formed in conjunction with the stem or bonnet so that pressure changes on one side of the wiper seal will not be instantly transferred to the other side of the wiper seal. In this embodiment, a slow equalization of pressures may be desirable so that associated particulate matter may be retained away from the packing gland. In this embodiment the wiper seal is not expected to take the place of the packing, but it may do so in other envisioned embodiments.

In yet another embodiment, microchannels in the flange outside of the wiper may permit the fluids to equalize their pressure on either side of the wiper. In this embodiment it may be preferable to size the microchannels to prevent particulate matter from moving towards the packing gland. Alternatively, or additionally, the microchannels may be formed of tortuous paths that will trap particulate matter when fluids flow towards the packing gland and expel any trapped particulate matter when fluids flow away from the packing gland.

Weep hole 7113 may be seen to have a downward slope from packing gland 7031 to circumferential channel 7101. For example, and without limitation, the weep hole may have a diameter of about 3/16 inch.

Weep hole 7113 is shown opposite the lubrication channel 7038. In this configuration and orientation any particulate matter denser than the associated fluid will gravitationally settle toward the bottom of packing gland 7031. By orienting weep hole 7113 at the bottom of packing gland 7031, a majority of settled particulate matter will be expelled away from packing 7030 ahead of any fluids.

In some situations, particulate matter in fluids may be lighter than fluids they are suspended in. In that case, it may be desired to have a weep hole oriented at the top of the bonnet. In some situations, it may not be known if the particulate matter is more or less dense than its associated fluid, or if different types of particulate matter may be associated with different fluids. This may result in some particulate matter being buoyant within the associated fluid and some sinking. Therefore, it may be advantageous to configure and orient a weep hole at the bottom of the bonnet and another at the top.

In another of many embodiments, a screen or particle filter may be placed over weep hole 7113 to prevent any particulate matter from entering weep hole 7113 from the bonnet 2020.

Although relative terms such as “outer,” “inner,” “upper,” “lower,” and similar terms have been used herein to describe a spatial relationship of one element to another, it is understood that these terms are intended to encompass different orientations of the various elements and components in addition to the orientation depicted in the figures. Furthermore, as used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements. The terms “substantially,” “approximately,” “generally,” and “about” are defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A gate for a gate valve, the gate comprising:
a gate bore extending from a first surface to a second surface, the gate bore having a central axis and an axis of symmetry; and
a pocket formed in the first surface along an arcuate portion of the gate bore and bisected by the axis of symmetry, the pocket defined by a bottom surface, a first sidewall, an opposite sidewall, and an outside edge wherein:
the bottom surface extends radially from an entrance edge of the gate bore recessed from the first surface to the outside edge;
the first sidewall extends from the entrance edge to the outside edge; and
the opposite sidewall extending from the entrance edge to the outside edge.

2. The gate of claim 1, wherein:
an inner distance between the first sidewall and the opposite sidewall at the entrance edge is greater than an outer distance between the first sidewall and the opposite sidewall at the outside edge.

3. The gate of claim 1, wherein the outside edge is arcuate.

4. The gate of claim 1, wherein the outside edge is arcuate and convex relative to the central axis of the gate valve.

5. The gate of claim 4, wherein the outside edge has a radius substantially equal to a radius of the gate bore.

6. The gate of claim 1, wherein the outside edge is linear.

7. The gate valve of claim 1, wherein the first sidewall, the opposite sidewall, and the outside edge are chamfered at the first surface.

8. The gate of claim 1, wherein a first corner is rounded between the first sidewall and the outside edge; and
a second corner is rounded between the opposite sidewall and the outside edge.

9. The gate of claim 1, wherein the bottom surface slopes from the entrance edge to the outside edge.

10. The gate of claim 1, wherein a backwall extends from the bottom surface to the outside edge.

11. The gate of claim 1, wherein:
the outside edge is arcuate; and
the outside edge has a radius substantially equal to a radius of the gate bore.

12. The gate of claim 1, wherein:
the outside edge is arcuate and convex relative to the central axis of the gate valve; and
the first sidewall, the opposite sidewall, and the outside edge are chamfered at the first surface.

13. The gate of claim 12, wherein the outside edge has a radius substantially equal to a radius of the gate bore.

14. The gate of claim 12, wherein a first corner is rounded between the first sidewall and the outside edge; and
a second corner is rounded between the opposite sidewall and the outside edge.

15. The gate of claim 12, wherein the bottom surface slopes from the entrance edge to the outside edge.

16. The gate of claim 1, wherein:
the outside edge is linear; and
the first sidewall, the opposite sidewall, and the outside edge are chamfered at the first surface.

17. The gate of claim 16, wherein a first corner is rounded between the first sidewall and the outside edge; and
a second corner is rounded between the opposite sidewall and the outside edge.

18. The gate of claim 16, wherein the bottom surface slopes from the entrance edge to the outside edge.

19. A gate for a gate valve, the gate comprising:
a gate bore extending from a first surface to a second surface, the gate bore having a central axis and an axis of symmetry; and
a pocket formed in the first surface along an arcuate portion of the gate bore and bisected by the axis of symmetry, the pocket defined by a backwall, a bottom surface, a first sidewall, and an opposite sidewall wherein:
the backwall is vertically recessed from the first surface and radially displaced from the gate bore;
the bottom surface extends from the backwall to an entrance edge of the gate bore recessed from the first surface;
the bottom surface extends radially from the entrance edge to the backwall;
the first sidewall extends from the entrance edge to the outside edge;
the opposite sidewall extending from the entrance edge to the outside edge;
a first corner is rounded between the first sidewall and the backwall; and
a second corner is rounded between the opposite sidewall and the backwall.

20. The gate of claim 19, wherein:
the backwall is arcuate and convex relative to the central axis of the gate valve; and
the first sidewall, the opposite sidewall, and the backwall are chamfered at the first surface.
